(19) United States
(12) Patent Application Publication
(10) Pub. No.: US 2016/0033047 A1
(43) Pub. Date: Feb. 4, 2016

(54) BACK PRESSURE BLOCKING SLIDING VALVE

(71) Applicants: Gyeong-soon SHIN, Seocho-go Seoul (KR); YOU & I SOLUTION CO., LTD, Suwon city Gyeonggi-do (KR)

(72) Inventor: Joon-young SEO, Osan Gyeonggi-do (KR)

(21) Appl. No.: 14/761,096

(22) PCT Filed: Jan. 16, 2014
(86) PCT No.: PCT/KR2014/000449

§ 371 Date: Sep. 8, 2015

(30) Foreign Application Priority Data
Jan. 18, 2013 (KR) 10-2013-0005818
Sep. 6, 2013 (KR) 10-2013-0106984

(51) Int. Cl. F16K 3/316; F16K 15/06; F16K 3/02; F16K 3/10; F16K 3/18

(52) U.S. Cl. CPC F16K 3/316; F16K 3/10; F16K 3/18; F16K 3/0254; F16K 15/06

(57) ABSTRACT

The present invention relates to a back pressure blocking sliding valve including: a valve body having a fluid inlet part, a fluid outlet part, and a fluid passing cavity; a mover with an upper part having a blocking plate for blocking the flow of the fluid under a back pressure, the mover being horizontally moved into the fluid passing cavity when blocking the back pressure; and a mover shifting unit for horizontally shifting the mover, wherein the fluid passing cavity of the valve is normally not blocked so as to allow a normal flow of the fluid, but when a back pressure is generated in the pipe system, the mover is horizontally shifted to a blocking position so as to make the blocking plate of the mover efficiently block the backflow of the fluid, even in a process in which powder is produced.

### TECHNICAL FIELD

The present invention generally relates to a back pressure blocking valve that can quickly block an abrupt inflow of air or a back flow of a fluid in a pipe system used to maintain a constant pressure, and a forward flow of a fluid such as a gas in a process of manufacturing a semiconductor, an LCD, or a chemical. More particularly, the present invention relates to a back pressure blocking sliding valve including: a valve body having a fluid inlet part, a fluid outlet part, and a fluid passing cavity; a mover with an upper part having a blocking plate for blocking a flow of the fluid under a back pressure, the mover being horizontally moved into the fluid passing cavity when blocking back pressure; and a mover shifting unit for horizontally shifting the mover, wherein during a normal operation of the pipe system in which no obstacle is present in the fluid passing cavity of the valve, the fluid passing cavity of the valve is not blocked and thus allows a normal flow of the fluid as in a straight pipe, but when a back pressure is generated in the pipe system, the mover is horizontally shifted to a blocking position, and the blocking plate of the mover floats at the blocking position and blocks the backflow of the fluid, even in a process in which powder is produced.

### BACKGROUND ART

In general, a vacuum device is typically used in a semiconductor manufacturing line, etc. Here, to produce vacuum pressure in the process, a vacuum pump is used. Semiconductor manufacturing devices in the line perform unit processes such as vapor deposition, etching, etc. in a vacuum state (or a very low pressure state). When the vacuum pump is abruptly broken or an operation thereof is abruptly stopped, atmospheric air may be introduced into the vacuum device, thereby forming particles on products processed in a vacuum chamber and causing serious damage to the unit processes.

To prevent the above-mentioned damage, a back pressure blocking valve is used at a location between the vacuum chamber and the vacuum pump. An example of conventional back pressure blocking valves is disclosed in Korean Patent No. 706661. In the conventional back pressure blocking valve, a blocking plate used to block a back pressure is operated by gravity. Further, the conventional back pressure blocking valve has a meandering structure in which a fluid path is bent at least once. Thus, the conventional back pressure blocking valve is problematic in that when the flow speed of a fluid quickly and suddenly increases or when a great amount of fluid suddenly flows in a pipe system, the valve may efficiently resist neither the quick and sudden increase in the flow speed of the fluid nor the sudden flow of the great amount of fluid.

Further, in a process of manufacturing semiconductors, etc., a chemical vapor deposition (CVD) is performed to form a thin film on a wafer by spraying reaction gas under vacuum pressure. The chemical vapor deposition typically produces a great amount of particles (hereinbelow, referred to as “powder”) such as silicon dioxide (SiO2) or alumina (Al2O3). Here, in the back pressure blocking valve, the blocking plate is always exposed to the fluid path, so the blocking plate may be easily deformed by the powder. When the blocking plate is deformed by the powder, the blocking plate may not repeatedly perform the blocking function under precise pressure and may not realize the desired sealing effect.

Further, the powder may be layered on the blocking plate. When the blocking plate having the powder is used to block a back pressure, the powder remains between the blocking plate and a sealing member, so the blocking plate may fail to realize the desired sealing effect and may cause leakage. Thus, the blocking plate may fail to perform a back pressure blocking function.

Further, the powder layered on the blocking plate causes a change in the mass of the blocking plate. The change in the mass of the blocking plate may increase a pressure required to raise the blocking plate during an operation of blocking a back pressure, so the blocking plate having the powder may not float and may fail to efficiently block the back pressure.

Further, a conventional gate valve has neither the function of blocking back pressure nor the meandering structure in which the fluid path is bent, so the gate valve may resist a quick and sudden increase in a flow speed of a fluid or a sudden flow of a great amount of fluid. However, when the powder is layered on an internal drive unit and a blocking plate, the powder remains between the blocking plate and a sealing member, so the blocking plate may fail to realize desired sealing effect and may cause leakage. Thus, the blocking plate may fail to perform a back pressure blocking function.

### DISCLOSURE

### Technical Problem

Accordingly, the present invention has been made keeping in mind the above problems occurring in the related art, and the present invention is intended to propose a back pressure blocking sliding valve that has an improved structure and can quickly block an abrupt inflow of air or a back flow of a fluid in a pipe system used in a process of manufacturing a semiconductor, an LCD, or a chemical, and in which a mover having a blocking plate seated on an upper part thereof is provided, so during a normal operation of the pipe system in which no obstacle is present in a fluid passing cavity of the valve, the fluid passing cavity of the valve is not blocked and thus allows a normal flow of the fluid as in a straight pipe, but when a back pressure is generated in the pipe system, the mover is horizontally shifted to a blocking position, and the blocking plate of the mover floats at the blocking position and blocks the backflow of the fluid, even in a process in which a great amount of powder is produced, a process in which an increase in the pumping speed is required, and a process in which the installation of a back pressure blocking valve results in a reduction in conductance, thus no valve for blocking a back pressure is used in the process in the related art.

Further, the present invention is also intended to propose a back pressure blocking sliding valve which includes: a valve body; a mover that has a blocking plate on an upper part so as to block a fluid inlet part and is shifted to a blocking position in a fluid passing cavity when a back pressure is generated in a pipe system; and a mover shifting unit shifting the mover, and which further includes: a powder inlet prevention cylinder provided in the valve body; and a powder inlet prevention ring provided in the powder inlet prevention cylinder so as to move upward and downward in response to compressed air supplied from the outside, so the valve can prevent introduction of powder into a cavity receiving the mover, etc. by using the powder inlet prevention ring.

### Technical Solution

In order to achieve the above object, according to one aspect of the present invention, there is provided a back pressure blocking sliding valve, including: a valve body including: a fluid inlet part and a fluid outlet part provided in upper and lower parts of the valve body, respectively, with a fluid passing cavity defined between the fluid inlet part and the fluid outlet part; a mover including a blocking plate seated thereon, the blocking plate functioning to block the fluid inlet part, the mover being shifted to the fluid passing cavity when it is required to block a fluid flow; and a mover shifting unit shifting the mover, wherein when a back pressure is generated, the mover shifting unit shifts the mover to a blocking position at which the blocking plate blocks the fluid inlet part, and the blocking plate seated on the mover floats due to a pressure difference produced by the back pressure inside the valve body, and closes the fluid inlet part, thereby blocking the back pressure.

Here, the mover shifting unit may include: a drive unit that is a pneumatic actuating cylinder or an electric motor; and a rotary shaft of the drive unit, the rotary shaft combined with the mover, so that the mover is shifted to the blocking position by a rotation of the rotary shaft.

Further, the mover may include: a rotary shaft holding part combined with the rotary shaft; and a mover body on which the blocking plate is seated, with a circular opening provided in the mover body, wherein the circular opening has a diameter smaller than a diameter of the blocking plate, so that the blocking plate is seated on the circular opening of the mover body.

Further, the mover shifting unit may include: a drive unit that is a pneumatic actuating cylinder or an electric motor; and a link unit connected to the drive unit at a first end thereof and connected to the mover at a second end thereof, so that when the link unit extends in response to an operation of the drive unit, the mover is shifted to the blocking position.

Further, the mover may include: a mover body on which the blocking plate is seated, with a circular opening provided in the mover body; and a link unit holding part combined with the link unit, wherein the circular opening has a diameter smaller than a diameter of the blocking plate, so that the blocking plate is seated on the circular opening of the mover body.

Further, the mover body may be provided with a wheel for realizing easy movement of the mover body.

Further, the blocking plate may have a circular disc shape, with an outer diameter of the blocking plate being larger than a diameter of the fluid inlet part, and a protrusion being provided on a lower surface of the blocking plate by protruding downward, so that when the blocking plate is seated on the mover, the protrusion limits a horizontal movement of the blocking plate.

Further, an O-ring may be provided in the valve body at a location at which the valve body comes into contact with the blocking plate, so that the O-ring realizes a sealing effect when the blocking plate floats due to the pressure difference produced by the back pressure inside the valve body, and closes the fluid inlet part, and blocks the back pressure.

Further, a height A from a surface of the valve body on which the O-ring is provided to an upper surface of the mover or a height D to the lower surface of the blocking plate from which the protrusion protrudes may be set to be less than a sum of a thickness B of the blocking plate and a height C of the protrusion formed on the lower surface of the blocking plate, that is, A or D<(B+C).

Further, the valve body may further include: a powder inlet prevention cylinder; and a powder inlet prevention ring provided in the powder inlet prevention cylinder so as to move upward and downward by compressed air or compressed gas supplied from outside into the powder inlet prevention cylinder, so that the powder inlet prevention ring blocks inflow of powder into a cavity receiving the mover and the mover shifting unit.

Further, the powder inlet prevention ring may have a cylindrical structure that is stepped twice, the powder inlet prevention ring moving upward and downward by the compressed air or the compressed gas supplied into the powder inlet prevention cylinder via a compressed air inlet part provided on the powder inlet prevention cylinder.

Further, a cavity having a predetermined thickness (t) may be provided in a lower part of the mover body of the mover on which the blocking plate is seated, so that when the powder inlet prevention ring starts to be opened in response to a back pressure generation signal generated from outside, the cavity of the mover body allows the mover shifting unit to shift the mover to the blocking position at which the blocking plate blocks the fluid inlet part even before the powder inlet prevention ring is fully opened.

Here, the thickness (t) of the cavity provided in the lower part of the mover body may be 1 mm or more.

Further, a gas inlet part may be provided on the valve body so as to supply powder absorption preventing gas from outside into the valve body, and a gas outlet part may be provided on the valve body so as to allow the powder absorption preventing gas supplied from the gas inlet part to flow along an inner circumferential surface of the valve body, thereby preventing the powder from being absorbed on an inner circumferential surface of the powder inlet prevention ring or on the inner circumferential surface of the valve body.

Further, the gas outlet part may have a circular path shape that allows the powder absorption preventing gas to flow along the inner circumferential surface of the valve body.

Further, a cylindrical gas guide ring having a diameter smaller than an inner diameter of the valve body may be provided in the valve body, so that the gas guide ring guides the powder absorption preventing gas to the inner circumferential surface of the valve body when the powder absorption preventing gas is discharged from the gas outlet part.

### Advantageous Effects

The back pressure blocking sliding valve according to the present invention is advantageous in that during a normal operation of a pipe system in which no obstacle is present in a fluid passing cavity of the valve, the valve allows a high speed flow of a fluid as in a straight pipe, thus realizing improved flow characteristics, but when a back pressure is generated in the pipe system, a mover is horizontally shifted to a blocking position, and a blocking plate of the mover floats at the blocking position and blocks the flow of the fluid, thus efficiently blocking the back pressure, so the valve can be efficiently operated even in a process in which powder is produced.

Further, another advantage of the present invention resides in that a mover shifting unit shifts the mover having the blocking plate seated thereon to the blocking position in response to a back pressure generation signal, thus changing a straight fluid path to a bent fluid path having a meandering structure, so the present invention can primarily retard the inflow of a back pressure and can quickly produce a pressure difference for the blocking plate seated on the mover, thereby allowing the blocking plate to quickly float and to quickly perform a precise back pressure blocking function.

Further, another advantage of the present invention resides in that the valve additionally includes: a powder inlet prevention cylinder provided in a valve body; and a powder inlet prevention ring provided in the powder inlet prevention cylinder so as to move upward and downward in response to compressed air supplied from the outside, so the valve can prevent introduction of powder into a cavity receiving the mover, etc. by using the powder inlet prevention ring.

Further, yet another advantage of the present invention resides in that the valve further includes a cylindrical gas guide ring that has a diameter smaller than the inner diameter of the valve body and is provided in the valve body, thereby guiding powder absorption preventing gas to the inner circumferential surface of the valve body when the powder absorption preventing gas is discharged from a gas outlet part, and thus preventing absorption of powder on the inner circumferential surface of the valve body or in gaps formed inside the valve.

Further, still another advantage of the present invention resides in that in response to a back pressure generated from the outside, compressed air or compressed gas is supplied to the powder inlet prevention cylinder and starts to open the powder inlet prevention ring, and in that a cavity having a predetermined thickness t is formed in a lower part of the mover body on which the blocking plate is seated so that even before the powder inlet prevention ring is fully opened, the mover shifting unit can shift the mover to the blocking position at which the blocking plate blocks the fluid inlet part, thus minimizing the time required to shift the mover to the fluid inlet part blocking position and increasing the back pressure blocking speed of the blocking plate.

Further, still another advantage of the present invention resides in that to prevent powder from being absorbed on the inner circumferential surface of the valve body or in gaps formed inside the valve, a gas inlet part is provided on the valve so as to supply the powder absorption preventing gas from the outside of the valve body into the fluid inlet part, and the gas outlet part is provided in the valve body so as to allow the powder absorption preventing gas supplied from the gas inlet part to flow along the inner circumferential surface of the valve body, so the valve can prevent the powder from being absorbed on the inner circumferential surface of the valve body or on the inner circumferential surface of the powder inlet prevention ring, or in the gaps formed inside the valve body, thereby being efficient for use in a pipe system of a process in which powder is produced.

### DESCRIPTION OF DRAWINGS

FIG. 1 is a view showing an appearance of a back pressure blocking sliding valve according to a first embodiment of the present invention;

FIG. 2 is an exploded perspective view showing the back pressure blocking sliding valve according to the first embodiment of the present invention;

FIGS. 3(a) to 3(d) are views showing various examples of a blocking plate seated on a mover of the back pressure blocking sliding valve according to the first embodiment of the present invention;

FIGS. 4(a) to 4(c) are views showing a process in which the blocking plate blocks a fluid inlet part of the first embodiment of the present invention in response to generation of a back pressure;

FIGS. 5(a) and 5(b) are views showing the flows of gas during a normal operation and a blocking operation of the back pressure blocking sliding valve according to the first embodiment of the present invention, respectively;

FIG. 6 is a view showing an appearance of a back pressure blocking sliding valve according to a second embodiment of the present invention;

FIGS. 7(a) and 7(b) are views showing a process in which a blocking plate blocks a fluid inlet part of the second embodiment of the present invention in response to generation of a back pressure;

FIGS. 8(a) and 8(b) are plane views showing an internal structure shown in FIGS. 7(a) and 7(b);

FIG. 9 is a view showing an appearance of a mover of the back pressure blocking sliding valve according to the second embodiment of the present invention;

FIGS. 10(a) and 10(b) are views showing the flows of gas during a normal operation and a blocking operation of the back pressure blocking sliding valve according to the second embodiment of the present invention, respectively;

FIGS. 11(a) to 11(e) are views showing various examples of the blocking plate of the back pressure blocking sliding valve according to the present invention;

FIGS. 12(a) and 12(b) are views illustrating the determination of a thickness of the blocking plate of the back pressure blocking sliding valve according to the present invention, and FIGS. 12(c) and 12(d) are enlarged views of FIGS. 12(a) and 12(b), respectively;

FIG. 13 is a view showing an appearance of a back pressure blocking sliding valve according to a third embodiment of the present invention, in which a powder inlet prevention cylinder is provided in the fluid outlet part of the first embodiment;

FIG. 14 is a view showing an appearance of a back pressure blocking sliding valve according to a fourth embodiment of the present invention, in which a powder inlet prevention cylinder is provided in the fluid outlet part of the second embodiment;

FIG. 15 is an exploded perspective view of the back pressure blocking sliding valve according to the third embodiment of the present invention;

FIGS. 16(a) to 16(e) are views showing a process in which a blocking plate blocks a fluid inlet part of the third embodiment of the present invention in response to generation of a back pressure;

FIGS. 17(a) to 17(e) are views showing a process in which a blocking plate blocks a fluid inlet part of the fourth embodiment of the present invention in response to generation of a back pressure;

FIGS. 18(a) and 18(b) are views showing cavities having a predetermined thickness (t) formed in lower parts of mover bodies according to the third and fourth embodiments of the present invention, respectively;

FIG. 19 is a view showing a gas inlet part for supplying powder absorption preventing gas in the back pressure blocking sliding valve according to the third embodiment of the present invention;

FIG. 20 is a view showing a gas inlet part for supplying powder absorption preventing gas in the back pressure blocking sliding valve according to the fourth embodiment of the present invention;

FIGS. 21(a) and 21(b) are a sectional view and a plane view showing a structure of the present invention in which the powder absorption preventing gas flows into the valve body, respectively;

FIGS. 22 and 23 are views showing a back pressure blocking sliding valve in which a gas guide ring is provided in a valve body according to another embodiment of the present invention; and

FIGS. 24(a) and 24(b) are views showing a further embodiment of a gas guide ring provided in a valve body of the present invention.

<Description of the Reference Numerals in the Drawings>

| | |
|---|---|
| 10: valve body | 11: fluid inlet part |
| 12: inlet cover | 13: fluid outlet part |
| 14: outlet cover | 15: sidewall |
| 16: locking members | 17: O-ring |
| 20: mover | 21: mover body |
| 22: rotary shaft holding part | |
| 22a: rotary shaft locking hole | |
| 24, 25, 26: wheel | 27: link unit holding part |
| 30: blocking plate | 31: blocking surface |
| 32: protrusion | 40: mover shifting unit |
| 41: drive unit | 42: rotary shaft |
| 43: link unit | 50: powder inlet prevention cylinder |
| 51: powder inlet prevention ring | |
| 52, 53: compressed air inlet part | |
| 55: space | 56: gas guide ring |
| 61: gas inlet part | 62: gas outlet part |
| 63: circular path | 70: powder |

### BEST MODE

Hereinbelow, a back pressure blocking sliding valve according to the present invention will be described in detail with reference to the accompanying drawings.

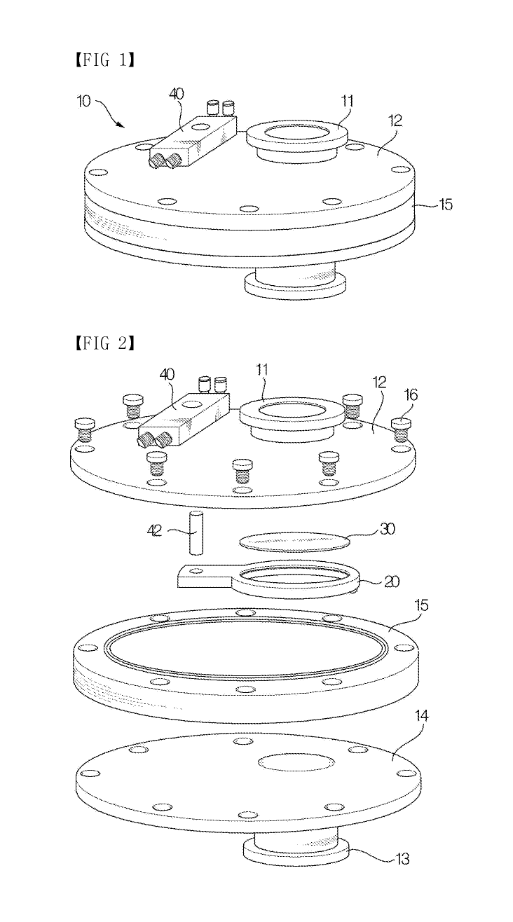

The back pressure blocking sliding valve according to the present invention is a back pressure blocking valve that can quickly block an abrupt inflow of air or a back flow of a fluid in a pipe system used to maintain a constant pressure and a forward flow of a fluid such as a gas in a process of manufacturing a semiconductor, an LCD, or a chemical. As shown in FIG. 1 to FIG. 9, the back pressure blocking sliding valve of the present invention includes: a valve body 10 having a cylindrical or hexahedral shape and provided with a fluid inlet part 11 having a predetermined length in a fluid inlet direction, an inlet cover 12 covering the fluid inlet part 11, a fluid outlet part 13 having a predetermined length in a fluid outlet direction, an outlet cover 14 covering the fluid outlet part 13, and a sidewall 15 defining a fluid passing cavity between the inlet cover 12 and the outlet cover 14; a mover 20 provided with a blocking plate 30 seated on an upper part of the mover 20 so that the blocking plate 30 can block the fluid inlet part 11 inside the valve body, the mover 20 being shifted to a blocking position inside the fluid passing cavity when a back pressure is generated; and a mover shifting unit 40 shifting the mover 20. Thus, in response to a back pressure generation signal indicative of generation of a back pressure, the mover shifting unit 40 shifts the mover 20 to the blocking position at which the blocking plate blocks the fluid inlet part 11. Here, the blocking plate 30 seated on the mover 20 floats due to a pressure difference formed by the back pressure inside the valve body and closes the fluid inlet part, so the back pressure blocking sliding valve of this invention can efficiently block the back pressure.

A back pressure blocking sliding valve according to the first embodiment of the present invention will be described with reference to FIGS. 1 to 5(b).

The valve body 10 of the back pressure blocking sliding valve according to the first embodiment of the present invention includes: a fluid inlet part 11 having a predetermined length in a fluid inlet direction; an inlet cover 12 integrated with the fluid inlet part 11 into a single body and having a predetermined diameter, and covering the fluid inlet part 11; a fluid outlet part 13 having a predetermined length in a fluid outlet direction; an outlet cover 14 integrated with the fluid outlet part 13 into a single body and having a predetermined diameter, and covering the fluid outlet part 13; and a sidewall 15 defining a fluid passing cavity between the inlet cover 12 and the outlet cover 14. Here, the inlet cover 12 integrated with the fluid inlet part 11 is tightly assembled with the upper surface of the sidewall 15 using a plurality of locking members 16, for example, bolts in such a way that the junction between the inlet cover 12 and the sidewall 15 is sealed. Further, the outlet cover 14 integrated with the fluid outlet part 13 is tightly assembled with the lower surface of the sidewall 15 using a plurality of locking members 16, for example, bolts in such a way that the junction between the outlet cover 14 and the sidewall 15 is sealed. Thus, the valve body 10 has a sealed structure.

A mover shifting unit 40 is provided on the upper surface of the inlet cover 12 at a location on a side of the fluid inlet part 11. The mover shifting unit 40 includes: a drive unit 41 that is a pneumatic actuating cylinder or an electric motor; and a rotary shaft 42 of the drive unit. The mover 20 having the blocking plate 30 seated thereon is combined with the rotary shaft 42 of the drive unit 41. Thus, when a back pressure generation signal indicating a sudden stopping of a vacuum pump or the generation of a back pressure in the pipe system is applied to the drive unit 41, electricity or pneumatic pressure is supplied to the drive unit 41 so that the rotary shaft 42 of the drive unit 41 rotates at a predetermined angle, thereby moving the mover 20 to a position for blocking the fluid inlet part 11.

The mover 20 includes: a mover body 21 that is provided with a circular opening in a central portion thereof, the circular opening having a diameter smaller than the diameter of the blocking plate 30 so that the blocking plate 30 can be seated on the edge of the circular opening of the mover body 21; and a rotary shaft holding part 22 having a rotary shaft locking hole 22a so that the rotary shaft holding part 22 is combined with the rotary shaft 42. A wheel 24 is provided on the lower surface of the mover body 21 so that when the rotary shaft 42 rotates at the predetermined angle, the wheel 24 slides on the inner circumferential surface of the valve body 10, thereby allowing the mover 20 to easily move.

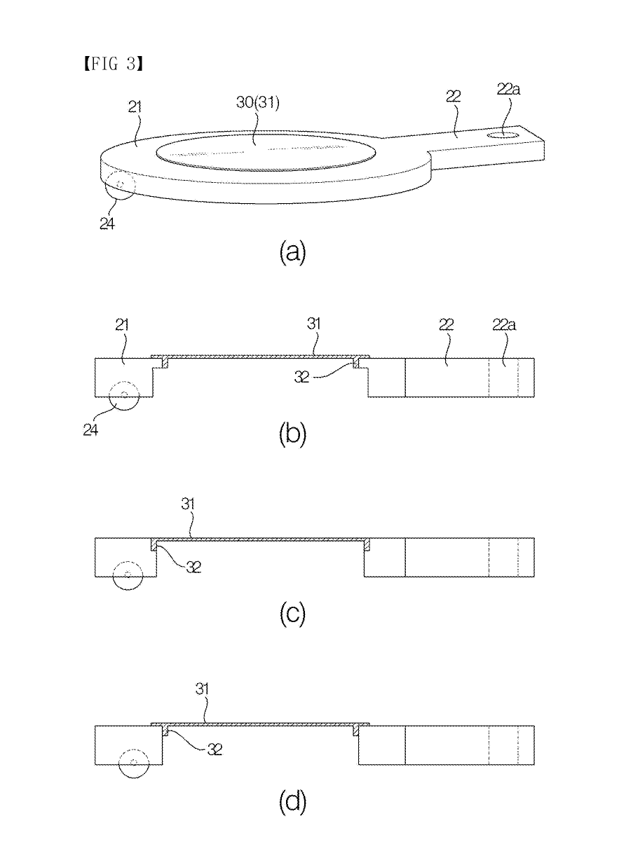

As shown in FIGS. 3(a) to 3(d), the blocking plate 30 seated on the mover body 21 is a thin circular disc having a flat blocking surface 31. Here, the outer diameter of the blocking plate 30 is larger than the diameter of the fluid inlet part 11. A protrusion 32 is provided on the lower surface of the blocking plate 30 by protruding downward at a position near the circumferential surface of the circular opening of the mover body 21, so that when the blocking plate 30 is seated on the mover 20, the protrusion 32 can limit a horizontal movement of the blocking plate 30.

In other words, as shown in FIG. 3(b), the mover body 21 may be provided with a protruding step so that when the blocking plate 30 is seated on the mover body 21, the protrusion 32 of the blocking plate 30 may be stopped by the protruding step of the mover body 21, thereby limiting a leftward and rightward movement of the blocking plate 30. Alternatively, as shown in FIG. 3(c), the mover body 21 may be provided with a depressed step so that when the blocking plate 30 is seated on the mover body 21, the protrusion 32 of the blocking plate 30 may be stopped by the depressed step of the mover body 21, thereby limiting a leftward and rightward movement of the blocking plate 30. As a further alternative, as shown in FIG. 3(d), the mover body 21 may be configured without having a step so that when the blocking plate 30 is seated on the mover body 21, the protrusion 32 of the blocking plate 30 may be stopped by the circumferential surface of the circular opening of the mover body 21, thereby limiting a leftward and rightward movement of the blocking plate 30.

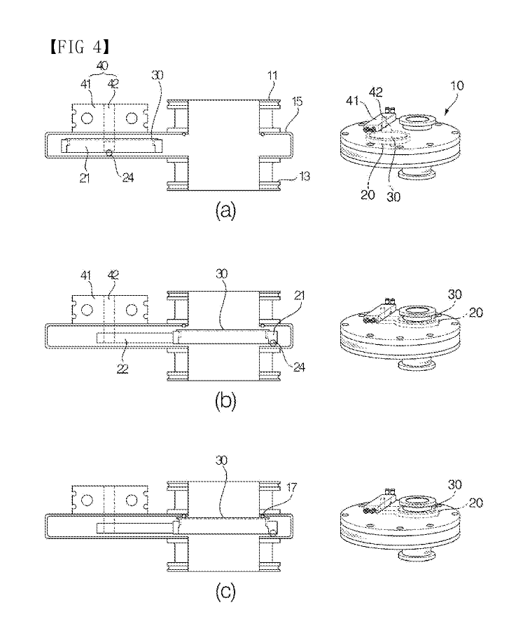

Hereinbelow, a process in which the blocking plate of the back pressure blocking sliding valve according to the first embodiment of the present invention blocks the fluid inlet part will be described with reference to FIGS. 4(a) to 4(c), and FIGS. 5(a) and 5(b).

During a normal operation of the pipe system in which the fluid normally flows in the pipe system, no obstacle is present in a fluid path that is the fluid passing cavity defined from the fluid inlet part 11 to the fluid outlet part 13 of the valve body 10, so that the fluid normally flows without being disturbed as in a straight pipe, as shown in FIGS. 4(a) and 5(a).

However, when the vacuum pump of the pipe system is abruptly stopped or a back pressure is generated in the pipe system, a back pressure generation signal is output from a sensor. In response to the back pressure generation signal, electricity or pneumatic pressure is applied to the drive unit 41 and the rotary shaft 42 of the drive unit 41 rotates at a predetermined angle, so that the mover 20 that is provided with the blocking plate 30 seated thereon and is combined with the rotary shaft 42 rotates at the predetermined angle, as shown in FIG. 4(b). Thus, the mover 20 is completely shifted to the position for blocking the fluid inlet part 11. Here, it is preferred to completely shift the mover 20 to the position for blocking the fluid inlet part 11 within 0.5 seconds after the generation of the back pressure generation signal. When the mover 20 having the blocking plate 30 seated thereon is completely shifted to the blocking position, the mover 20 changes the straight fluid path to a bent fluid path having a meandering structure (structure having a bent portion), thereby primarily retarding the inflow of the back pressure.

When the mover 20 having the blocking plate 30 is shifted to the position for blocking the fluid inlet part 11, the back pressure is concentrated into the circular opening formed in the central portion of the mover body 21, as shown in FIGS. 4(c) and 5(b), so that a pressure difference is generated due to the back pressure concentrated into the circular opening of the mover body 21. Accordingly, the blocking plate 30 seated on the mover 20 floats, thereby closing the fluid inlet part 11 and blocking the back pressure. Here, it is preferred that the blocking plate 30 floats and closes the fluid inlet part within 0.5 seconds after the generation of the back pressure generation signal.

To realize desired sealing effect when the blocking plate 30 floats and closes the fluid inlet part 11, an O-ring 17 is provided in the valve body 10 at a location at which the valve body 10 comes into contact with the blocking plate 30 when the blocking plate 30 blocks the back pressure by closing the fluid inlet part 11.

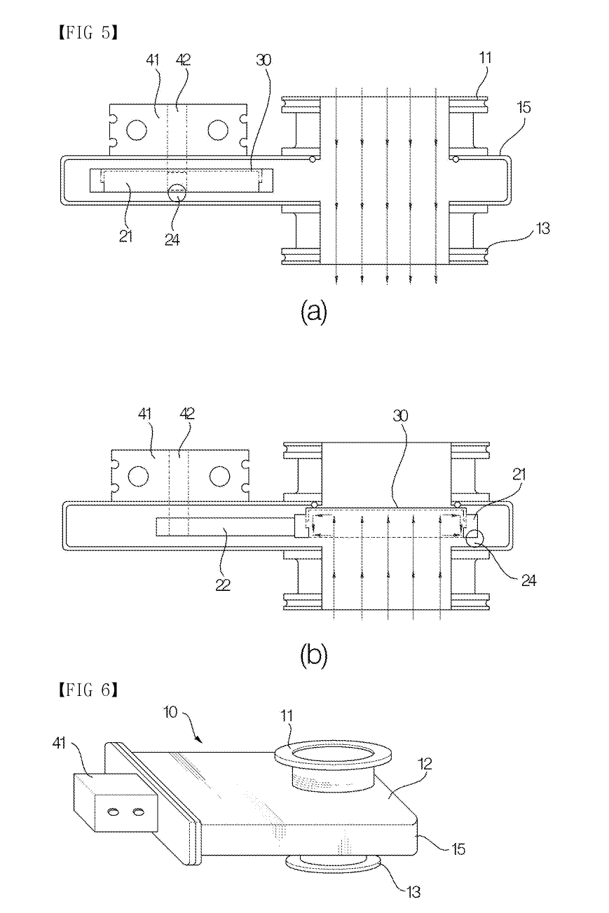

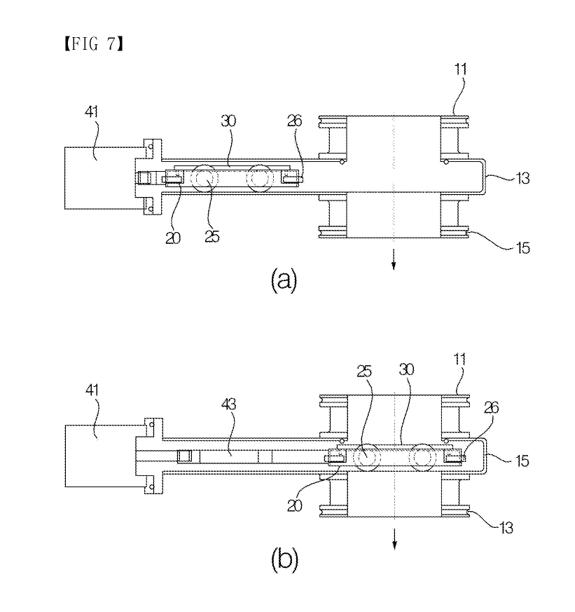

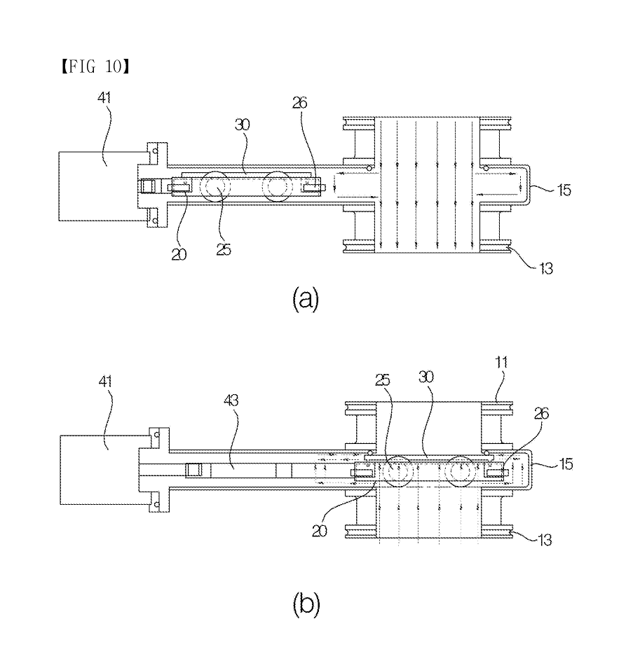

Thereafter, a back pressure blocking sliding valve according to the second embodiment of the present invention will be described with reference to FIGS. 6 to 10(b).

The valve body 10 in the back pressure blocking sliding valve according to the second embodiment of the present invention includes: a fluid inlet part 11 having a predetermined length in a fluid inlet direction; an inlet cover 12 integrated with the fluid inlet part 11 into a single body and having a predetermined diameter, and covering the fluid inlet part 11; a fluid outlet part 13 having a predetermined length in a fluid outlet direction; an outlet cover 14 integrated with the fluid outlet part 13 into a single body and having a predetermined diameter, and covering the fluid outlet part 13; and a sidewall 15 defining a fluid passing cavity between the inlet cover 12 and the outlet cover 14. Thus, the valve body 10 has a sealed structure with a longitudinal hexahedral shape. As shown in FIG. 6, the inlet cover 12, the sidewall 15, and the outlet cover are integrated with the fluid inlet part 11 and the fluid outlet part 13 into a single body. Here, the elements of the valve body 10 may be assembled into a sealed structure using locking members, for example, bolts.

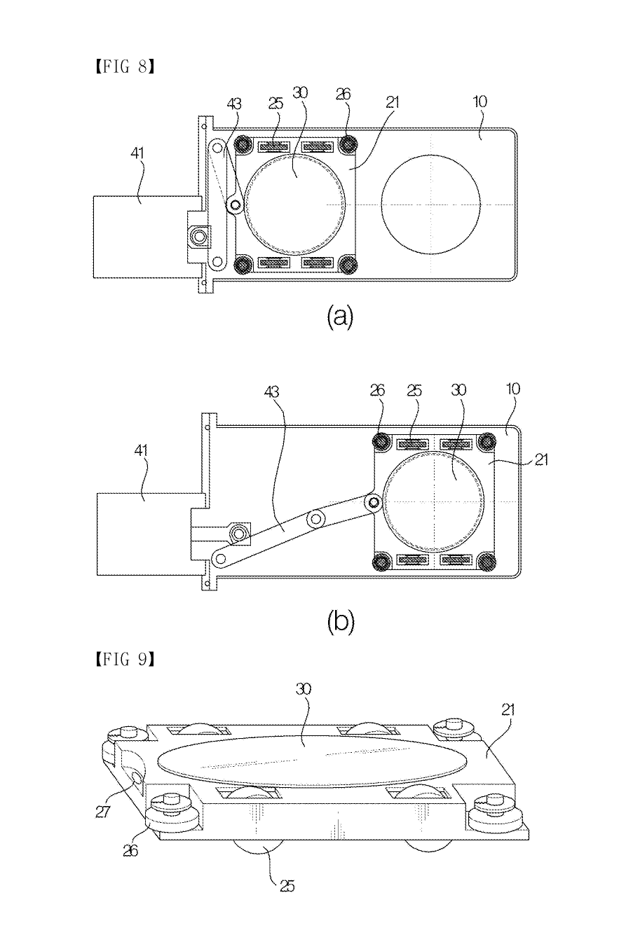

As shown in FIGS. 7(a), 7(b), 8(a), and 8(b), the mover shifting unit includes: a drive unit 41 that is provided on a side of the valve body 10; and a link unit 43 that pushes or pulls the mover 20 so as to shift the mover 20 between positions at which the mover 20 closes or opens the fluid inlet part 11.

The drive unit 41 may use a pneumatic actuating cylinder or an electric motor. When the drive unit 41 is operated, the link unit 43 comprising a plurality of links connected to a drive shaft of the drive unit 41 at a first end thereof is extended or compressed, thereby pushing or pulling the mover 20 connected to the link unit 43. Thus, the mover 20 is shifted between positions at which the mover 20 closes or opens the fluid inlet part 11.

The mover 20 includes: a mover body 21 having a blocking plate 30 seated thereon; and a link unit holding part 27 combined with the link unit 43. The mover body 21 is provided with a circular opening having a diameter smaller than the diameter of the blocking plate 30, so that the blocking plate 30 can be seated on the edge of the circular opening of the mover body 21.

Thus, when a back pressure generation signal indicating a sudden stopping of a vacuum pump or the generation of a back pressure in the pipe system is applied to the drive unit 41, electricity or pneumatic pressure is supplied to the drive unit 41 so that the drive unit 41 is operated to extend the link unit 43. Accordingly, the mover 20 connected to a second end of the link unit 43 is shifted to a position for blocking the fluid inlet part 11.

As shown in FIG. 9, the mover 20 includes: the mover body 21 that is provided with the circular opening in a central portion thereof, the diameter of the circular opening being smaller than the diameter of the blocking plate 30 so that the blocking plate 30 can be seated on the edge of the circular opening of the mover body 21; and the link unit holding part combined with the link unit 43. Lower wheels 25 are provided on the lower surface of the mover body 21 so that when the rotary shaft 42 rotates at a predetermined angle, the lower wheels 25 slide on the lower surface inside the valve body 10, thereby allowing the mover 20 to easily move. The mover body 21 also includes side wheels 26 that slide on the side surface inside the valve body 10, thereby allowing the mover 20 to easily move.

Hereinbelow, the process of blocking the fluid inlet part using the blocking plate in the back pressure blocking sliding valve according to the second embodiment of the present invention will be described with reference to FIGS. 7(a) and 7(b), FIGS. 8(a) and 8(b), and FIGS. 10(a) and 10(b).

During a normal operation of the pipe system in which the fluid normally flows, no obstacle is present in a fluid path that is the fluid passing cavity defined from the fluid inlet part 11 to the fluid outlet part 13 of the valve body 10, so that the fluid normally flows without being disturbed as in a straight pipe, as shown in FIGS. 7(a), 8(a), and 9(a).

However, when the vacuum pump of the pipe system is abruptly stopped or a back pressure is generated in the pipe system, a back pressure generation signal is output from a sensor. In response to the back pressure generation signal, the drive unit 41 is operated to extend the link unit 43 combined with the drive unit 41, thereby horizontally shifting the mover 20 connected to the link unit 43 and having the blocking plate 30 to a position for blocking the fluid inlet part 11, as shown in FIGS. 7(b), 8(b), and 10(b). When the mover 20 having the blocking plate 30 seated thereon is completely shifted to the blocking position, the mover 20 changes the straight fluid path to a bent fluid path having a meandering structure (structure having a bent portion), thereby primarily retarding the inflow of the back pressure (it is preferred that the change of the fluid path is finished within 0.5 seconds after the generation of the back pressure generation signal). When the mover 20 having the blocking plate 30 is shifted to the position for blocking the fluid inlet part 11, the back pressure is concentrated into the circular opening formed in the central portion of the mover body 21, so that a pressure difference is generated due to the back pressure concentrated into the circular opening of the mover body 21. Accordingly, the blocking plate 30 seated on the mover 20 floats, thereby closing the fluid inlet part 11 and blocking the back pressure (it is preferred that the blocking plate 30 floats and closes the fluid inlet part 11 within 0.5 seconds after the generation of the back pressure generation signal). Here, to realize desired sealing effect when the blocking plate 30 floats and closes the fluid inlet part 11, an O-ring 17 is provided in the valve body 10 at a location at which the valve body 10 comes into contact with the blocking plate 30 when the blocking plate 30 blocks the back pressure by closing the fluid inlet part 11.

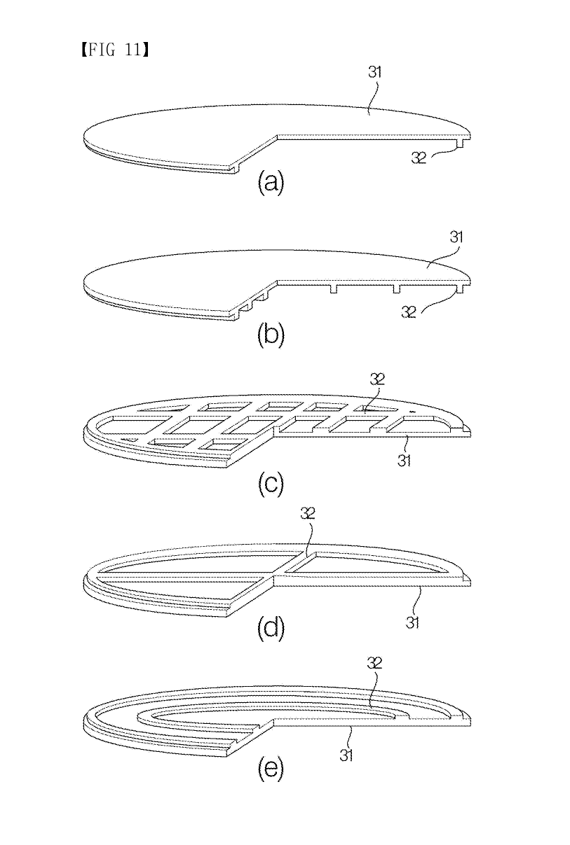

In each of the first and second embodiments of the present invention, a protrusion having a predetermined length may be provided on the lower surface of the blocking surface 31 of the blocking plate 30 in the back pressure blocking sliding valve. Here, the protrusion may have various structures as shown in FIGS. 11(a) to 11(e). When a large diameter plate is used as the blocking plate 30 according to the diameters of the fluid inlet part and the fluid outlet part, a plurality of protrusions 32 may be provided on the blocking plate 30 in an effort to prevent bending of the blocking plate 30. In other words, the protrusion 32 may be used to increase the blocking speed and to minimize the weight of the blocking plate 30, and to prevent bending of the blocking plate 30. In the present invention, the blocking plate 30 may be used in an overturned position.

The blocking plate 30 functions to close the fluid inlet part 11 by floating due to a pressure difference generated by a back pressure formed inside the valve body 10, so that to realize an increase in the blocking speed and to precisely block the back pressure, it is preferred that the blocking plate 30 is light. Here, the weight of the blocking plate 30 may be determined according to a range of back pressure that can be blocked at a location between the fluid inlet part and the fluid outlet part.

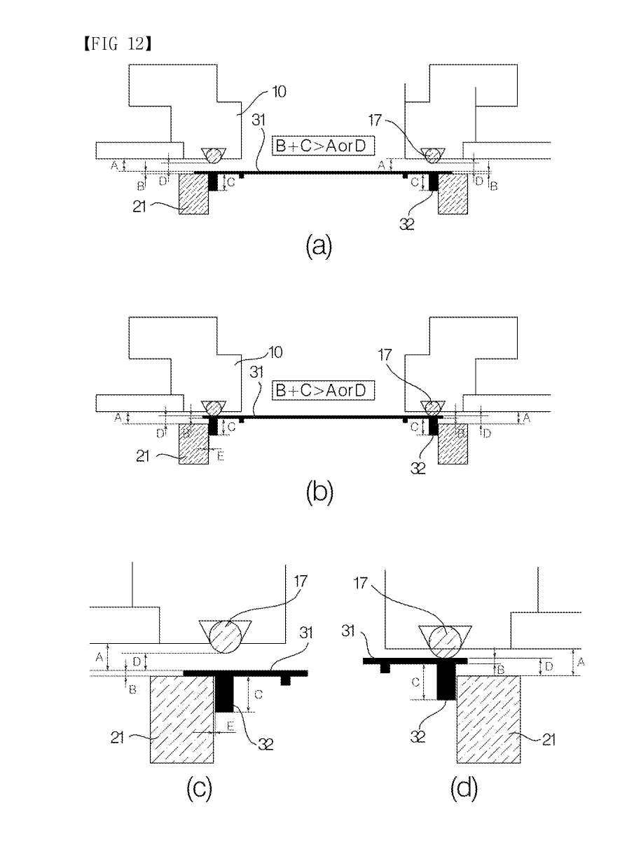

FIGS. 12(a) and 12(b) are views illustrating the determination of a thickness of the blocking plate of the back pressure blocking sliding valve according to the present invention, and FIGS. 12(c) and 12(d) are enlarged views of FIGS. 12(a) and 12(b), respectively;

As shown in FIGS. 12(a) and 12(c), the height A from the surface of the valve body on which the O-ring is installed to the upper surface of the mover is set to be less than the sum of the thickness B of the blocking plate and the height C of the protrusion 32 formed on the lower surface of the blocking plate 30, that is, A or D<(B+C). The above-mentioned relationship in the dimensions of the elements is intended to prevent the blocking plate 30 from being undesirably removed from the mover 20, wherein the blocking plate 30 is configured to be seated on the upper surface of the mover body 21 and the seated position of the blocking plate 30 is held by the protrusion 32 of the blocking plate 30 without having an additional locking means.

Further, as shown in FIGS. 12(b) and 12(d), the height D to the lower surface of the blocking plate from which the protrusion protrudes is set to be less than the sum of the thickness B of the blocking plate and the height C of the protrusion provided on the lower surface of the blocking plate, that is, D<(B+C). The above-mentioned relationship in the dimensions of the elements is intended to prevent the blocking plate 30 from being undesirably removed from the mover body 21, wherein the blocking plate 30 is configured to float due to a pressure difference between the upper part and the lower part of the blocking plate 30 and to block the fluid inlet part while being sealed by the O-ring. Here, when the value B+C is greater than the value D, the protrusion 32 of the blocking plate 30 can be maintained in a state inserted into the mover body 21, thus preventing the blocking plate 30 from being undesirably removed from the mover body 21.

Due to the above-mentioned construction, the back pressure blocking valve of the present invention can quickly block the inflow of back pressure when an abrupt inflow of air or a back flow of a fluid is generated in the pipe system used to maintain a constant pressure and a forward flow of a fluid. However, during a normal operation of the pipe system in which no obstacle is present in the fluid passing cavity of the valve body, the fluid can normally flow without being disturbed as in a straight pipe. Thus, the back pressure blocking valve of the present invention can be efficiently used in a process in which powder is produced.

Thereafter, third and fourth embodiments of the present invention will be described in which respective powder inlet prevention cylinders are added to the fluid outlet parts 30 of the first and second embodiments.

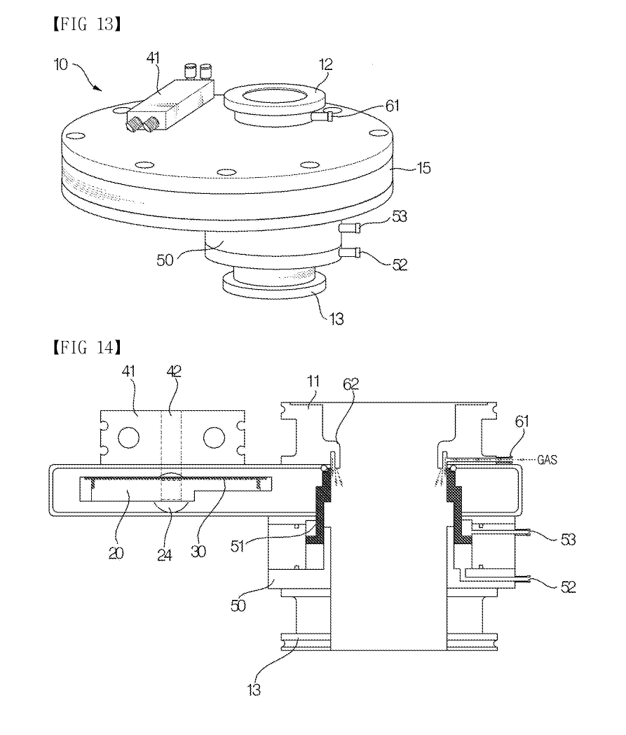

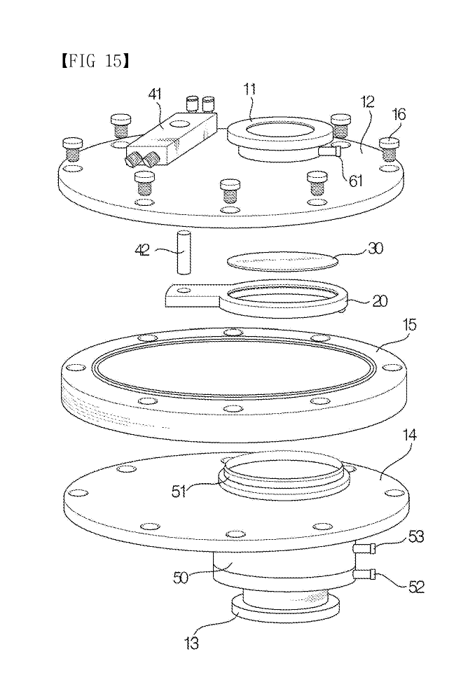

In the third embodiment of the present invention, a powder inlet prevention cylinder 50 is added to the fluid outlet part 30 of the back pressure blocking sliding valve according to the first embodiment, as shown in FIGS. 13 to 15.

Further, two compressed air inlet parts 52 and 53 may be provided on the powder inlet prevention cylinder 50 so as to supply compressed air or compressed gas from the outside into the powder inlet prevention cylinder 50. When compressed air is supplied into the powder inlet prevention cylinder 50 via the compressed air inlet part 52, a cylindrical powder inlet prevention ring 51 moves upward. However, when compressed air is supplied into the powder inlet prevention cylinder 50 via the compressed air inlet part 53, the cylindrical powder inlet prevention ring 51 moves downward. In the present invention, to move the powder inlet prevention ring 51, compressed gas instead of the compressed air may be supplied into the powder inlet prevention cylinder 50 via one of the compressed air inlet parts 52 and 53.

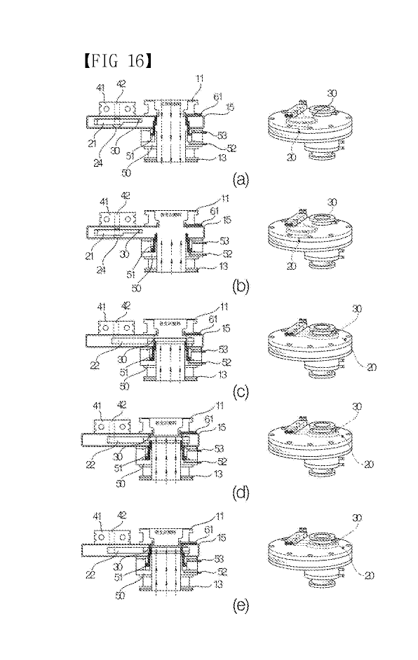

When compressed air is supplied via the compressed air inlet part 52 and the cylindrical powder inlet prevention ring 51 moves upward, the powder inlet prevention ring 51 can block a cavity receiving both the mover 20 and the mover shifting unit 40 therein, as shown in FIGS. 16(a) and 16(e), thereby blocking the inflow of powder into the cavity receiving both the mover 20 and the mover shifting unit 40 therein.

Here, the powder inlet prevention ring 51 has a cylindrical structure that is stepped twice. As shown in FIGS. 16(b) and 16(d), the powder inlet prevention ring 51 is configured such that when the powder inlet prevention ring 51 moves downward by the compressed air, the powder inlet prevention ring 51 is stopped by a protruding step formed in the powder inlet prevention cylinder 50, thereby being prevented from further moving downward.

Hereinbelow, a process in which the blocking plate of the back pressure blocking sliding valve according to the third embodiment of the present invention blocks the fluid inlet part will be described with reference to FIGS. 16(a) to 16(e).

FIG. 16(a) shows a normal operation of the pipe system in which the fluid such as gas normally flows forward in the pipe system. During the normal operation of the pipe system, the powder inlet prevention ring 51 moves upward so that the powder inlet prevention ring 51 blocks the cavity receiving both the mover 20 and the mover shifting unit 40. Accordingly, the back pressure blocking sliding valve can block the inflow of powder into the cavity receiving both the mover 20 and the mover shifting unit 40.

FIGS. 16(b) to 16(e) show a process in which the blocking plate 30 blocks the fluid inlet part 11 in response to a back pressure generation signal output from a sensor when the vacuum pump of the pipe system is abruptly stopped and a back pressure is generated in the pipe system.

When the drive unit 41 is operated to shift the mover 20 to the blocking position in response to the back pressure generation signal, compressed air is supplied into the powder inlet prevention cylinder 50 via the compressed air inlet part 53 as shown in FIG. 16(b), so that the powder inlet prevention ring 51 moves downward. Thereafter, the rotary shaft 42 of the drive unit 41 rotates at a predetermined angle as shown in FIG. 16(c), so that the mover 20 connected to the rotary shaft 42 and having the blocking plate 30 thereon rotates at the predetermined angle, thereby being shifted to a position for blocking the fluid inlet part 11. When the mover 20 having the blocking plate 30 seated thereon is shifted to the position for blocking the fluid inlet part 11, the back pressure is concentrated into the circular opening formed in the central portion of the mover body 21, as shown in FIG. 16(d), so that a pressure difference is generated due to the back pressure concentrated into the circular opening of the mover body 21. Accordingly, the blocking plate 30 seated on the mover 20 floats, thereby closing the fluid inlet part 11 and blocking the back pressure.

Thereafter, as shown in FIG. 16(e), compressed air is supplied into the powder inlet prevention cylinder 50 via the compressed air inlet part 52, thereby moving the powder inlet prevention ring 51 upward until the powder inlet prevention ring 51 comes into contact with the blocking plate 30. Thus, the cavity that receives both the mover 20 and the mover shifting unit 40 therein is blocked, and the powder is prevented from being introduced into the cavity that receives both the mover 20 and the mover shifting unit 40 therein.

As shown in FIG. 14, the fourth embodiment of the present invention further includes the powder inlet prevention cylinder 50 in the fluid outlet part 30 of the back pressure blocking sliding valve according to the second embodiment of the present invention.

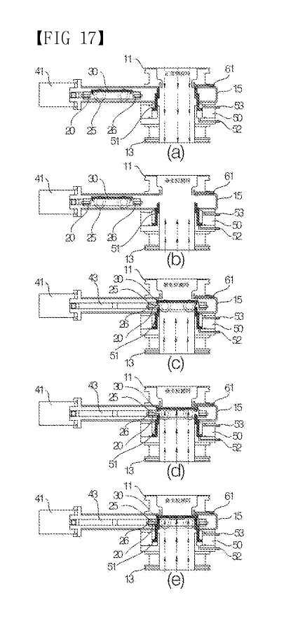

FIGS. 17(a) to 17(e) are views showing a process in which the blocking plate blocks the fluid inlet part of the fourth embodiment of the present invention in response to generation of a back pressure. Here, although the shape and structure of the mover 10 and the shape and structure of the mover shifting unit that shifts the mover 10 to the blocking position in the fourth embodiment of the present invention are different from those of the third embodiment of the present invention, the operational process of the fourth embodiment remains the same as that disclosed in the third embodiment shown in FIGS. 16(a) to 16(e). Thus, further explanation for the process in which the blocking plate blocks the fluid inlet part of the fourth embodiment of the present invention in response to generation of the back pressure is deemed unnecessary.

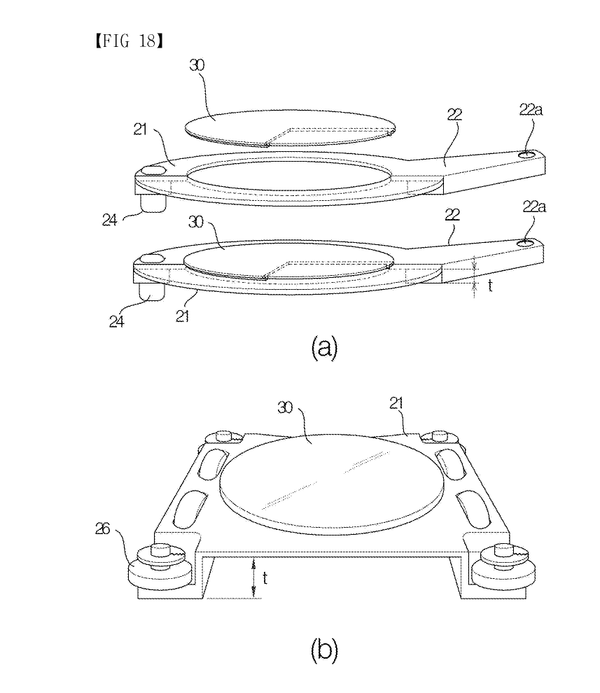

Further, in response to a back pressure generation signal, the powder inlet prevention ring 51 moves downward (see FIG. 16(b)), so that the mover 20 of the present invention can be shifted to the blocking position. Here, to allow the mover shifting unit 40 to shift the mover 20 to the blocking position at which the blocking plate blocks the fluid inlet part 11 even before the powder inlet prevention ring 51 moves downward and is fully opened, a cavity having a predetermined thickness t is formed in the lower part of the mover body 21 of the mover 20 on which the blocking plate 30 is seated, as shown in FIGS. 18(a) and 18(b). Due to the cavity of the mover body 21, the mover 20 can be shifted to the blocking position even before the powder inlet prevention ring 51 fully moves downward by a distance equal to the thickness t. Accordingly, the present invention can minimize the time required to shift the mover 20 to the blocking position at which the blocking plate 30 blocks fluid inlet part 11, and can increase the back pressure blocking speed of the blocking plate 30. Here, to more efficiently increase the back pressure blocking speed of the blocking plate 30, it is preferred to set the thickness t of the cavity to 1 mm or more.

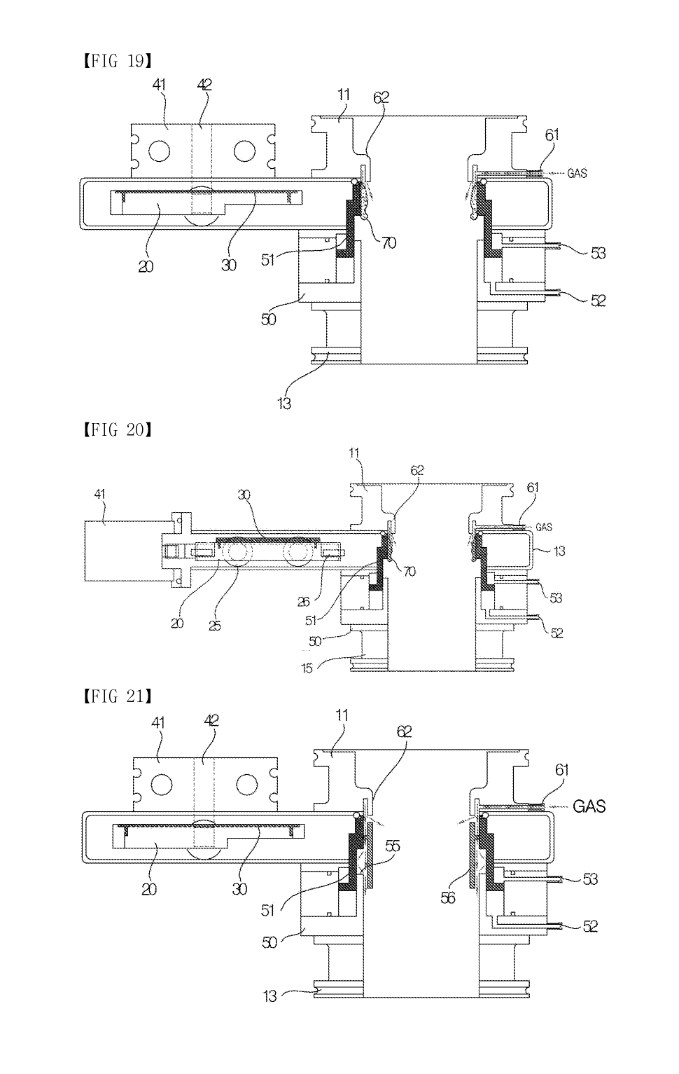

Further, in the present invention, to prevent powder from being absorbed on the inner circumferential surface of the valve body 10 or in gaps formed inside the valve, a gas inlet part 61 is provided on the valve body so as to supply powder absorption preventing gas from the outside of the valve body 10 into the fluid inlet part 11, and a gas outlet part 62 is provided in the valve body so as to allow the powder absorption preventing gas supplied from the gas inlet part 61 to flow along the inner circumferential surface of the valve body 10, as shown in FIGS. 19 and 21.

The method of using the powder absorption preventing gas supplied via the gas inlet part 61 may be variously changed according to the kind of the gas and the stage of a process.

1. In the case of supplying a small amount of nitrogen gas into the valve body via the gas inlet part 61 while the process is performed.

When nitrogen gas N2 is supplied into the valve body via the gas inlet part 61, the inlet nitrogen gas whirls along the gas outlet part 62 having a circular path 63 in a vertical direction, as shown in FIGS. 21(a) and 21(b). Here, when the nitrogen gas N2 whirls along the inner circumferential surface of the valve body 10 with the powder inlet prevention ring 51 provided on the inner circumferential surface of the valve body 10 and gaps remaining in the junction between the upper end of the powder inlet prevention ring 51 and the inner circumferential surface of the valve body 10, a gas layer is formed between powder and the inner circumferential surface of the valve body. Here, the gas layer can prevent the powder from being absorbed on the inner circumferential surface of the valve body or in the gaps, so that the valve having the powder inlet prevention ring 51 can prevent misoperation of the powder inlet prevention ring 51 in which the ring 51 may undesirably move upward and downward. Further, when the valve is not provided with the powder inlet prevention ring 51, the nitrogen gas may be used to prevent contamination of an O-ring used to seal the interior of the valve or a surface sealed by the O-ring.

Here, the amount of nitrogen gas N2 supplied via the gas inlet part 61 may be determined according to the capacity of a pump used to maintain a constant pressure inside the pipe system.

2. In the case of supplying nitrogen gas N2 into the valve body by injecting the nitrogen gas under high pressure via the gas inlet part 61 when the process is finished or stopped.

The N2 gas supplied into the valve body via the gas inlet part 61 under high pressure whirls along the gas outlet part 62 having the circular path 63 in a vertical direction. While whirling under high pressure, the nitrogen gas can wipe powder that was absorbed on the upper end of the powder inlet prevention ring 51, on the inner surface of the valve body 10 that are in contact with the upper end of the powder inlet prevention ring 51, and on the inner circumferential surface of the valve body 10 when the process was performed. Thus, the valve of the present invention can efficiently remove powder 70 absorbed on the inner circumferential surface of the valve body 10 and can prevent misoperation of the powder inlet prevention ring 51 during a next process in which the ring 51 may undesirably move upward and downward.

3. In the case of supplying cleaning gas (fluorine-based) into the valve body via the gas inlet part 61 when the process is performed or finished.

The fluorine gas F2 supplied into the valve body via the gas inlet part 61 whirls along the gas outlet part 62 having the circular path 63 in a vertical direction. While whirling under high pressure, the fluorine gas can wipe powder 70 that was absorbed on the upper end of the powder inlet prevention ring 51, on the inner surface of the valve body 10 that is in contact with the upper end of the powder inlet prevention ring 51, and on the inner circumferential surface of the valve body 10 when the process was performed. Thus, the valve of the present invention can efficiently remove the powder 70 absorbed on the inner circumferential surface of the valve body 10 and can prevent misoperation of the powder inlet prevention ring 51 during a next process in which the ring 51 may undesirably move upward and downward.

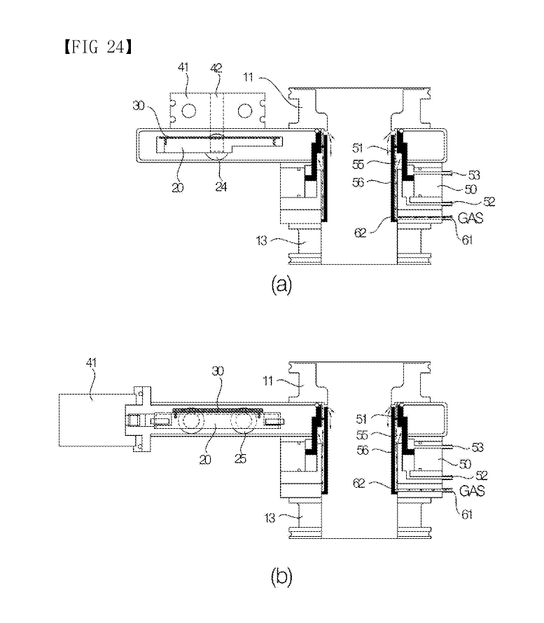

Hereinbelow, a back pressure blocking sliding valve in which a gas guide ring 56 is provided in the valve body 10 according to another embodiment of the present invention will be described with reference to FIGS. 23 and 24.

In this embodiment, a cylindrical gas guide ring 56 having a diameter smaller than the inner diameter of the valve body 10 is provided in the valve body 10, so that the gas guide ring 56 can guide the powder absorption preventing gas to the inner circumferential surface of the valve body 10 when the powder absorption preventing gas is discharged from the gas outlet part 62.

When the powder inlet prevention ring 51 is provided in the valve body 10, the gas guide ring 56 may have a diameter smaller than the inner diameter of the powder inlet prevention ring 51, and may be provided on the inner circumferential surface of the powder inlet prevention ring 51.

Further, when the gas guide ring 56 is provided on the inner circumferential surface of the powder inlet prevention ring 51, at least two supports may be provided on the outer circumferential surface of the gas guide ring 56, thereby supporting the gas guide ring 56 on the inner circumferential surface of the powder inlet prevention ring 51.

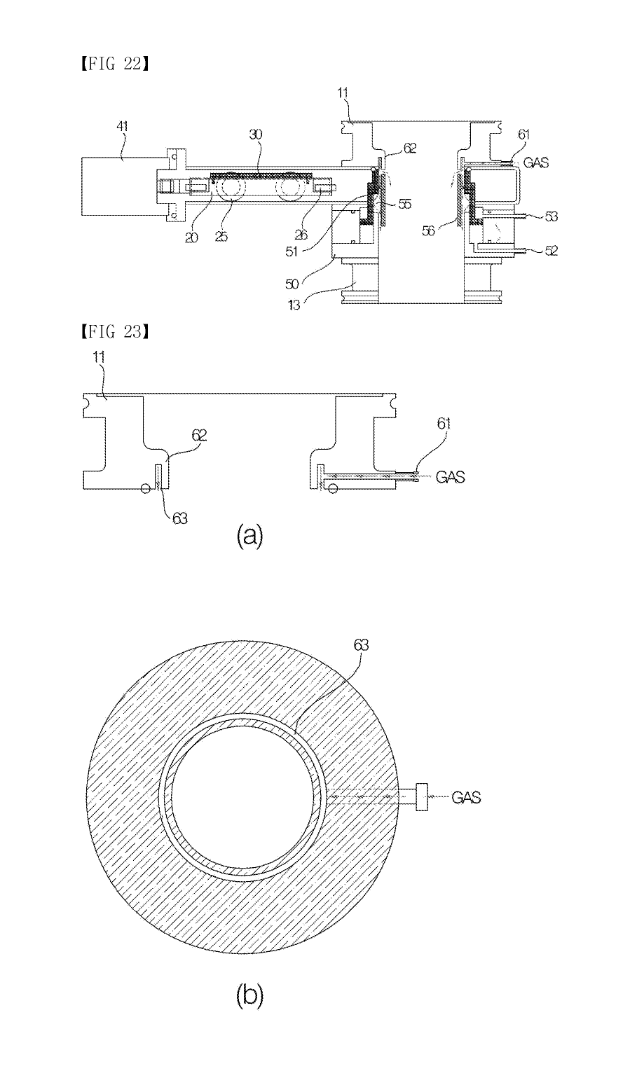

Further, when compressed air or compressed gas is supplied into the powder inlet prevention cylinder 50 via the compressed air inlet part 52 provided on the lower part of the powder inlet prevention cylinder 50, the powder inlet prevention ring 51 moves upward, thereby forming a space 55. Thus, powder 70 may be easily absorbed in the space 55 and on the inner circumferential surface of the valve body 10. To prevent the absorption of the powder, the gas guide ring 56 that is provided in the valve body 10 as shown in FIGS. 22 and 23 guides the powder absorption preventing gas discharged from the gas outlet part 62 to the space 55, thereby preventing misoperation of the powder inlet prevention ring 51.

Further, FIGS. 24(a) and 24(b) are views showing a further embodiment of a gas guide ring 56 provided in the valve body 10 of the present invention. In this embodiment, as shown in FIGS. 23(a) and 23(b), a gas inlet part 61 for supplying powder absorption preventing gas may be provided on the lower part of the valve body 10 or on the fluid outlet part 13, and a gas guide ring 56 having a length greater than the length of a portion having the gas outlet part 13 may be provided inside the valve body 10. When the powder absorption preventing gas supplied into the valve body 10 via the gas inlet part 61 is discharged via the gas outlet part 62, the powder absorption preventing gas is blocked by the gas guide ring 56 and flows upward to the space 55 defined between the gas guide ring 56 and the inner circumferential surface of the valve body 10, thereby preventing layering or absorption of powder in the space 55 or gaps.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention provides a back pressure blocking valve that can quickly block an abrupt inflow of air or a back flow of a fluid in a pipe system used to maintain a constant pressure and a forward flow of a fluid such as a gas in a process of manufacturing a semiconductor, an LCD, or a chemical. The back pressure blocking valve of the present invention may be efficiently used in a process of manufacturing semiconductors, LCDs, and chemicals.

1. A back pressure blocking sliding valve, comprising:
a valve body including: a fluid inlet part and a fluid outlet part provided in upper and lower parts of the valve body, respectively, with a fluid passing cavity defined between the fluid inlet part and the fluid outlet part;
a mover including a blocking plate seated thereon, the blocking plate functioning to block the fluid inlet part, the mover being shifted to the fluid passing cavity when it is required to block a fluid flow; and
a mover shifting unit shifting the mover,
wherein when a back pressure is generated, the mover shifting unit shifts the mover to a blocking position at which the blocking plate blocks the fluid inlet part, and the blocking plate seated on the mover floats due to a pressure difference produced by the back pressure inside the valve body, and closes the fluid inlet part, thereby blocking the back pressure.

2. The back pressure blocking sliding valve according to claim 1, wherein the mover shifting unit includes: a drive unit that is a pneumatic actuating cylinder or an electric motor; and a rotary shaft of the drive unit, the rotary shaft combined with the mover, so that the mover is shifted to the blocking position by a rotation of the rotary shaft.

3. The back pressure blocking sliding valve according to claim 2, wherein the mover includes: a rotary shaft holding part combined with the rotary shaft; and a mover body on which the blocking plate is seated, with a circular opening provided in the mover body, wherein the circular opening has a diameter smaller than a diameter of the blocking plate, so that the blocking plate is seated on the circular opening of the mover body.

4. The back pressure blocking sliding valve according to claim 1, wherein the mover shifting unit includes: a drive unit that is a pneumatic actuating cylinder or an electric motor; and a link unit connected to the drive unit at a first end thereof and connected to the mover at a second end thereof, so that when the link unit extends in response to an operation of the drive unit, the mover is shifted to the blocking position.

5. The back pressure blocking sliding valve according to claim 4, wherein the mover includes: a mover body on which the blocking plate is seated, with a circular opening provided in the mover body; and a link unit holding part combined with the link unit, wherein the circular opening has a diameter smaller than a diameter of the blocking plate, so that the blocking plate is seated on the circular opening of the mover body.

6. The back pressure blocking sliding valve according to claim 5, wherein the mover body is provided with a wheel for realizing easy movement of the mover body.

7. The back pressure blocking sliding valve according to claim 5, wherein the blocking plate has a circular disc shape, with an outer diameter of the blocking plate being larger than a diameter of the fluid inlet part, and a protrusion being provided on a lower surface of the blocking plate by protruding downward, so that when the blocking plate is seated on the mover, the protrusion limits a horizontal movement of the blocking plate.

8. The back pressure blocking sliding valve according to claim 7, wherein an O-ring is provided in the valve body at a location at which the valve body comes into contact with the blocking plate, so that the O-ring realizes a sealing effect when the blocking plate floats due to the pressure difference produced by the back pressure inside the valve body, and closes the fluid inlet part, and blocks the back pressure.

9. The back pressure blocking sliding valve according to claim 8, wherein a height (A) from a surface of the valve body on which the O-ring is provided to an upper surface of the mover or a height (D) to the lower surface of the blocking plate from which the protrusion protrudes is set to be less than a sum of a thickness (B) of the blocking plate and a height (C) of the protrusion formed on the lower surface of the blocking plate, that is, A or D<(B+C).

10. The back pressure blocking sliding valve according to claim 1, wherein the valve body further includes: a powder inlet prevention cylinder; and a powder inlet prevention ring provided in the powder inlet prevention cylinder so as to move upward and downward by compressed air or compressed gas supplied from outside into the powder inlet prevention cylinder, so that the powder inlet prevention ring blocks inflow of powder into a cavity receiving the mover and the mover shifting unit.

11. The back pressure blocking sliding valve according to claim 10, wherein the powder inlet prevention ring has a cylindrical structure that is stepped twice, the powder inlet prevention ring moving upward and downward by the compressed air or the compressed gas supplied into the powder inlet prevention cylinder via a compressed air inlet part provided on the powder inlet prevention cylinder.

12. The back pressure blocking sliding valve according to claim 11, wherein a cavity having a predetermined thickness (t) is provided in a lower part of a mover body of the mover on which the blocking plate is seated, so that when the powder inlet prevention ring starts to be opened in response to a back pressure generation signal generated from outside, the cavity of the mover body allows the mover shifting unit to shift the mover to the blocking position at which the blocking plate blocks the fluid inlet part even before the powder inlet prevention ring is fully opened.

13. The back pressure blocking sliding valve according to claim 12, wherein the thickness (t) of the cavity provided in the lower part of the mover body is 1 mm or more.

14. The back pressure blocking sliding valve according to claim 10, wherein a gas inlet part is provided on the valve body so as to supply powder absorption preventing gas from outside into the valve body, and a gas outlet part is provided on the valve body so as to allow the powder absorption preventing gas supplied from the gas inlet part to flow along an inner circumferential surface of the valve body, thereby preventing the powder from being absorbed on an inner circumferential surface of the powder inlet prevention ring or on the inner circumferential surface of the valve body.

15. The back pressure blocking sliding valve according to claim 14, wherein the gas outlet part has a circular path shape that allows the powder absorption preventing gas to flow along the inner circumferential surface of the valve body.

16. The back pressure blocking sliding valve according to claim 14, wherein a cylindrical gas guide ring having a diameter smaller than an inner diameter of the valve body is provided in the valve body, so that the gas guide ring guides the powder absorption preventing gas to the inner circumferential surface of the valve body when the powder absorption preventing gas is discharged from the gas outlet part.

17. The back pressure blocking sliding valve according to claim 16, wherein the gas guide ring has a length greater than a length of a portion having the gas outlet part.

18. The back pressure blocking sliding valve according to claim 15, wherein the gas guide ring has a length greater than a length of a portion having the gas outlet part.

19. The back pressure blocking sliding valve according to claim 14, wherein the gas guide ring has a length greater than a length of a portion having the gas outlet part.

20. The back pressure blocking sliding valve according to claim 3, wherein the mover body is provided with a wheel for realizing easy movement of the mover body.

21. The back pressure blocking sliding valve according to claim 1, wherein the blocking plate has a circular disc shape, with an outer diameter of the blocking plate being larger than a diameter of the fluid inlet part, and a protrusion being provided on a lower surface of the blocking plate by protruding downward, so that when the blocking plate is seated on the mover, the protrusion limits a horizontal movement of the blocking plate.

22. The back pressure blocking sliding valve according to claim 3, wherein the blocking plate has a circular disc shape, with an outer diameter of the blocking plate being larger than a diameter of the fluid inlet part, and a protrusion being provided on a lower surface of the blocking plate by protruding downward, so that when the blocking plate is seated on the mover, the protrusion limits a horizontal movement of the blocking plate.
